(19) United States
(12) Patent Application Publication
(10) Pub. No.: US 2015/0235235 A1
(43) Pub. Date: Aug. 20, 2015

(54) System for Authenticating Items

(71) Applicant: Moshe Koren, Hadera (IL)

(72) Inventor: Moshe Koren, Hadera (IL)

(21) Appl. No.: 14/704,593

(22) Filed: May 5, 2015

Related U.S. Application Data
(63) Continuation of application No. PCT/IL2014/050120, filed on Feb. 4, 2014.

(51) Int. Cl. G06Q 30/00

(52) U.S. Cl. CPC G06Q 30/0185

(57) ABSTRACT

Methods and systems for authenticating items and remotely detecting counterfeit items. Methods and systems for detecting counterfeit copies of genuine items.

### FIELD OF THE INVENTION

The present invention relates to a method for authenticating items and remotely detecting counterfeit items.

### BACKGROUND OF THE INVENTION

Modern forgery is a high-stakes race between producers, forgers and enforcement agencies. With increasing globalization and technical sophistication on both sides, an arms race of sorts has evolved. Many methods and systems attempt to ameliorate counterfeit, some of which are described below.

“Mobile Commerce: Opportunities and Challenges” (http://www.gs1.org/docs/mobile/GS1_Mobile_Com_Whitepaper.pdf) relates generally to cellular applications and specifically to authentication methods therefore, where each item is awarded a unique barcode. The application is able to scan the barcode and determine whether the item is genuine or counterfeit.

EP2131316 (A1) describes an authentication system using a manufacturer's data file. This file contains manufacture information, encoded in a product character string. A product data file provides a product code and manufacturer identification product data of the product character string. An authentication unit is provided for a query with the product character string by a terminal. An independent claim is included for an authentication method for verifying product validity by determining a product character string provided for product.

U.S. Pat. No. 7,856,554 (B2) describes a method of authenticating an object using an identifier. The method comprises steps of: (i) reading the identifier using a data reader to generate identity data; (ii) sending an authentication request from the data reader to a computer system, containing the identity data; (iii) receiving an authentication message from the computer system comprising an indication of authenticity, this being a description of an object associated with the identity data and a digital signature of the authentication message; (iv) verifying the digital signature; and (v) conveying the description of the object to a user if the signature is valid.

U.S. Pat. No. 8,249,350 (B2) describes a method and apparatus for protection of products and packaging against counterfeiting using dedicated authentication protocol coupled with portable devices. It is based on the product identification information, i.e., PIN, generated by the product manufacturer, stored in the product database and added to product or packaging in an open and/or a hidden form. The open part is directly available to the consumer before buying, opening or consuming the product or package, while the hidden part is only revealed after these operations. The hidden information can also be removed after a predefined interval of time or number of trials or usages. Both parts are communicated to an authentication server in a predefined order to verify the product or package authenticity. The presence, absence, or multiple requests for the same product PIN, allow confirmation or denial of product authenticity, and can also detect attempts at attacking the system for using counterfeited products.

U.S. Pat. No. 8,280,817 (B2) describes a subset of unique codes generated from a larger set of codes. The subset of codes is stored in a database on a secure server and each of the codes is marked on a corresponding instantiation of the product. The marked instantiations are distributed. During their distribution, the marked instantiations are verified for authenticity and for routing. This verification is performed by reading or scanning the codes on the instantiations, and transmitting that information to the secure server for comparison against the codes and other information located in the database contained therein.

WO2008065649 (A2) describes an authentication system enabling a customer to verify the authenticity of a product in a foolproof, secure and simple manner. A plurality of sets of secret numbers is generated, each set comprising a challenge portion and a response portion. These sets are stored on a remote server. Each set is associated with a different product. The customer sends a challenge portion to the server, and prompts the server to provide a response. If the response matches that of the product in hand, the product is known to be authentic. In another embodiment of the system, cellular transmission is used to power an electronic tag attached to the product and carrying authentication data.

WO2008056105 (A1) describes a computer-implemented method of verifying the authenticity of a product. The method comprises receiving an identification code associated with said product, and receiving at least one data item, each data item relating to a respective characteristic of said product. Said identification code is processed to determine at least one characteristic associated with said identification code and output data indicating the authenticity of said product is generated by processing said at least one data item relating to a characteristic of said product and said at least one characteristic associated with said identification code.

WO2009100935 (A1) describes a method and a system for extracting and transmitting information associated with a consumer good and stored in a database. According to the method, a descriptor of the consumer good is received, information associated with the descriptor is extracted from the database, and the extracted information is transmitted. During the receiving process, an SMS or MMS request message including the descriptor is processed. In the transmitting process, an SMS or MMS response message including the extracted information is sent.

DE102004032113 (A1) describes a method whereby the manufacturer marks the product with a specific authentication code using an internal code structure. A test address is also supplied, this being a mobile telephone number for an authentication station. On-line communication is made by SMS, with the purchaser sending the code and date from the packaging. The product name may also be transmitted. Decoding and authentication follow. Plausibility testing is carried out in conjunction with manufacturers' data. An automatic SMS response is generated, concerning the authenticity of the product.

One shortcoming of the aforementioned systems is that they simply provide means to authenticate products based on two variables—a database with information regarding said products, and an end user device which sends one piece of information, most commonly a barcode, to compare with information found in the database. Based on this comparison a binary decision is made as to authenticity. The systems' downside is that all a forger must do is to forge the barcode or identifying character on said item in order to receive an ‘authentic’ response from the database.

### SUMMARY OF THE INVENTION

The present invention describes a system and method for the authentication of products, comprising a unique mark (such as a barcode) assigned to each product manufactured and affixed upon the product; a remote server database with information regarding each product and its mark; and an end user with a device (such as a smartphone) which has an internet connection, a camera and GPS capabilities. Information regarding each unique mark is stored on a remote server database.

An end user will scan the mark or barcode using a device (such as a smartphone) equipped with a camera, internet access and GPS capabilities. The device sends information concerning the mark, along with the location of the item and the time of ID to the database, which will determine (based on the mark, time, and location of the scanned item) whether the item is authentic or not, and return a message to the user accordingly. In addition to the ID data, the time and location of the device will show whether the scanned item is authentic or counterfeit.

The process of the code authentication is described by the following steps:
Stage 1—An item is sent from manufacturer to distributors after being marked with a unique ID (UID). The UIDs, the type of item which has received the UID, distributors and intended destinations are recorded and send to servers of the system.
Stage 2—The item is offered for sale at a retail store or other point of sale. A potential buyer may now scan and send the UID of the product to the system servers for authentication.
Stage 3—An examination of whether the UID exists in the remote server database is carried out. If not, a reply is sent to the effect that the product is suspected as a forgery. If the code exists, the next step is taken:
Stage 4—A cross examination of the UID, location, and time data sent by the user is used to identify whether items with identical UID have been sold simultaneously in two or more locations. The method compares the probability of a simultaneous sale, based on the time and distance between multiple reports of the same UID sent to the system.
Stage 5—If an irregularity is detected in the cross-examination (said irregularity detected based on UID, time and location data) the system stores the UID of the item as counterfeit, and sends a message to the potential buyer that the item is a suspected counterfeit. If the system does not detect any irregularity in the cross-examination process, and the UID of the item has not previously been indicated as a counterfeit, the system returns a message to the user that the item is authentic, including the item's data.

The system as described above has many advantages over existing patents as described above. Firstly, while all other inventions simply utilize the single connection between the end user and the database, the invention described herein utilizes the power of multiple users in order to “teach” the system by enabling it to compare results received from different users. As mentioned above, in extant systems if a forger is able to successfully recreate the unique mark on a product they can, with ease, create unlimited forgeries by duplicating the mark.

However, in the system described herein, if as few as two people (simultaneously or at any interval) send the system a request regarding an item with an identical code, the system is able to flag the items as candidate forgeries. The invention makes it nearly impossible for forgers to commercially sale items, even if they do have the ability to recreate both the item and the unique code of an item.

Secondly, the system employs multiple users in order to very quickly flag and discover forgeries. The authorities may use this tool in order to pinpoint locations where forgeries may be sold and potentially remove them from the market quicker.

Lastly, the system allows the company whose product has been forged to be informed about which of its products are being forged, at what rate, and occurrence of sales of forged items.

The invention has the potential to seriously minimize, if not eliminate, forgeries and forgers.

### BRIEF DESCRIPTION OF THE DRAWINGS

FIG. 1 depicts the manufacturing and distributing process. Here one sees how products with unique marks are distributed via three distributers to two locations each.

FIG. 2 is a flowchart consistent with one embodiment of the validation and authentication process, beginning with the consumer scanning a product's barcode via a device. The device then sends the information, via network connectivity, to a remote server of the invention. This server authenticates using three levels of authentication, finally returning a message of ‘authentic’ or ‘suspected forgery’.

FIG. 3 conceptually illustrates a computer system with which some embodiments of the invention are implemented.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Furthermore just as every particular reference may embody particular methods/systems, yet not require such, ultimately such teaching is meant for all expressions notwithstanding the use of particular embodiments. Various modifications will remain apparent to those skilled in the art, since the generic principles of the present invention may produce one or several other embodiments.

The term ‘smartphone’ is hereinafter used to refer to any portable computing device with networked connectivity, including but not limited to a cellphone, PDA, tablet, phablet, and laptop computer.

In one embodiment of the invention, a manufacturer creates a series of products and brands each with a unique identifier (UID), which is implemented physically in the form of a barcode, RFID tag, or the like. The manufacturer then sends information regarding the products and their UIDs to the remote server database. Products are distributed to different retailers around the world; information about which items are in which shipments, pallets, batches, etc. can be added along the routes of the shipped goods, to allow for greater resolution in tracking groups of items. The tracking of groups is a key provision of the invention, since it provides a novel means to determine whether a given sale is of a genuine or counterfeit item, as will be explained further below; generally speaking, the retail store or stores at which a given batch is sold is identified, and any items identified as being from that batch but which is sold at a distant store, raises a flag of suspicion that the item is counterfeit. This flag is in addition to other flags that can be raised based on invalid UID, and items being sold that have already been marked as sold.

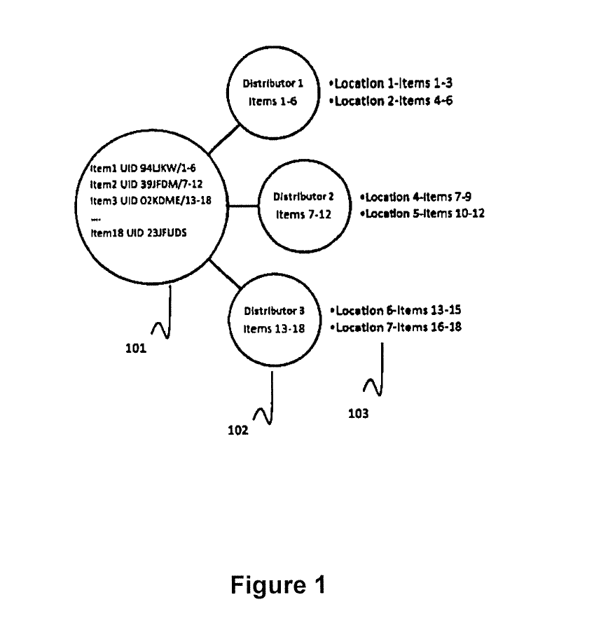

The method is illustrated in FIG. 1 which describes a part of the inventive process. Here one sees how products 1-18 with unique IDs (101) are distributed via three distributers (102) to two locations each (103).

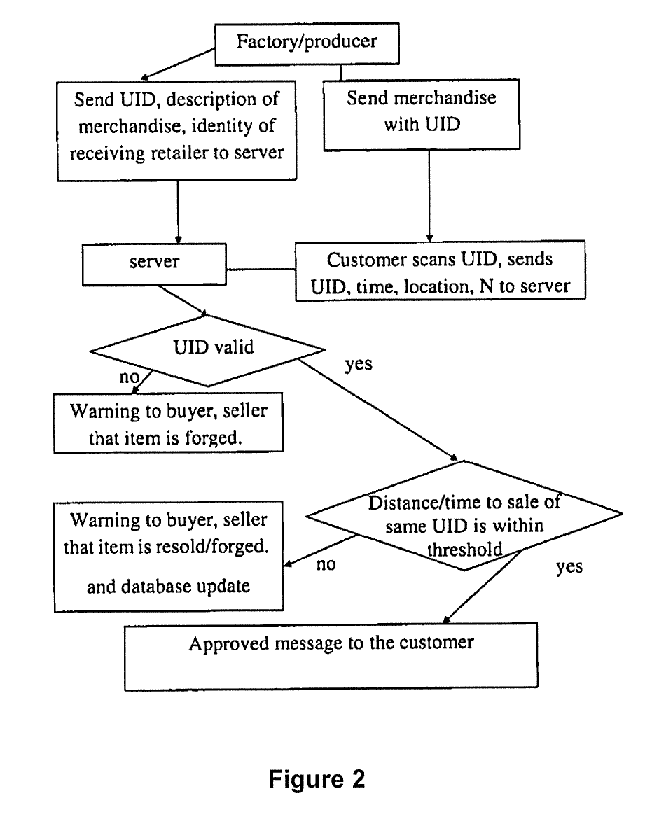

FIG. 2 is a flowchart of one embodiment of a validation and authentication process, beginning with the consumer opening an application of the invention running on a smartphone, and scanning the product's barcode also via his smartphone. This flowchart will be discussed in the following paragraphs.

Information regarding the UID of each item produced, shipping information such as which items are shipped together, shipper, destination for each item, and possibly other information is transmitted from the manufacturer, via network, to a server database.

When the item reaches a seller (such as a retailer) the retailer can in some embodiments optionally check the provenance of the item. For instance the seller can verify that the item UID is valid and has not already been sold. To do so the seller sends the UID and auxiliary information such as seller ID, location, and time to the server. The server will return the results of various checks, including whether the UID is a valid UID (i.e. exists in the server database as an item that has been manufactured), whether the item has already been flagged as sold, and possibly other checks. If the seller finds that the item does not have a valid UID, or has already been marked as sold, he can report the event to the manufacturer and/or system operator for purposes of taking corrective action, identifying faults in the distribution chain, etc.

When a customer comes to examine an item, he or she may likewise scan the UID. The UID, we recall, may be a implemented as a barcode, RFID chip, or any other physical device, object, or marking that may be scanned, for instance by means of optical scanning, electromagnetic waves as used by RFID scanners or Bluetooth devices, or the like.

Once the item has been scanned by a potential purchaser, the UID and auxiliary information such as buyer ID, location, and time are sent to the server.

A series of checks are then carried out.

Firstly, the server compares the UID with the database of valid UIDs. If the UID on the item does not exist in the database, it is immediately flagged as a potential forgery and the potential buyer is warned. This information is optionally also sent to the store owner, manufacturer, and distributor.

Secondly, the database is consulted as to whether the UID has already been flagged as sold. If the item's UID has been flagged as sold, the potential buyer is warned to the effect that the item is forged. This information is optionally also sent to the store owner, manufacturer, and distributor.

Thirdly, the system checks whether there were requests regarding identical UIDs or UIDs from the same batch, within a time period consistent with known transportation modes for the product and known locations of batch items. If items from the same batch are sold in disparate locations faster than they could have been reasonably transported, the database returns a message that the product is a suspected forgery. If this is not the case, the system returns a message that the product is authentic.

In some embodiments, the result of the check is sent in addition to auxiliary information regarding the product.

If the item passes all these checks, the buyer may now purchase the item. Once purchased, either the buyer, seller, or both may indicate the sale to the system. The system will now flag the item as having been sold once.

It is within provision of the invention that the number of times a particular item has been sold may be tracked by the system, as well as allowing the seller to send information to the remote server regarding the sale and the identity of the buyer. This will allow for multiple sales of the same item. For example if a buyer decides to resell an item, he can simply sell the item as secondhand, and any potential buyers will not be surprised to find upon checking that the item is marked in the server database as having been sold once. Similarly, the nth seller can simply mark the item as being ‘Nth hand’ and potential buyers will know whether the sale is bona fide. This of course will require either the buyers, sellers, or both to faithfully record the purchase to the server database of the system.

It is further within provision of the invention that particular retail locations be tracked; if items that are ostensibly part of a batch being sold in a particular location, are in fact sold at disparate locations, a suspected forgery can be reported. The location of the forgery sale can be tracked as well, for enforcement purposes.

In the event that the system returns a message that the product is authentic, information is stored regarding the unique mark of the product, as well as the time and location of the verification. This is in order to better allow verification of other requests of the same barcode or other barcodes from the same batch or shipment.

As mentioned, in the event of a sale, sale time, item UID, and other auxiliary information may be sent to the server database to allow for more efficacious operation of the system.

As will be evident, a database of sales information by retailer may be constructed by perusing the server database. This information may be of use to manufacturers, resellers, advertisers and the like. The locations of frequent forgeries may also become apparent, information which may be of use to manufacturers, law enforcement agencies, and other entities.

It is within provision of the invention that the database of UID information carry fields for auxiliary information. For example, a given set of items may be marked as stolen, if a theft occurs from a given factory, shipment, or retailer. Items which have been marked as stolen can be reported as such, when either a buyer or seller checks the status of items bearing these UIDs.

It is within provision of the invention that stocklists be updated automatically using the database of the inventive system. For instance a retailer may access the server database to determine what he has in stock and what has been sold, since the manufacturer will (optionally) indicate which retailers are to receive which items.

There is a possibility that a counterfeit item with a valid UID is sold first, before the genuine item bearing that UID is sold. To prevent such occurrences, it is within provision of the invention that a further check be undertaken, for instance correlating retailer or seller location with UID. If the intended retailer or seller ID and/or location for any given UID is recorded, then the location for the item UID can be checked. If the UID does not match the location of the item, the item may be flagged as a suspected forgery.

Similarly, it is within provision of the invention to restrict sales not only to a specific location, but to a specific range of time. For example, a food or pharmaceutical product which has a certain specified shelf life may have this shelf life indicated in the database of the invention. When the item is being checked, either by seller or by potential buyer, the expiration date is checked and if past, the item is flagged as expired.

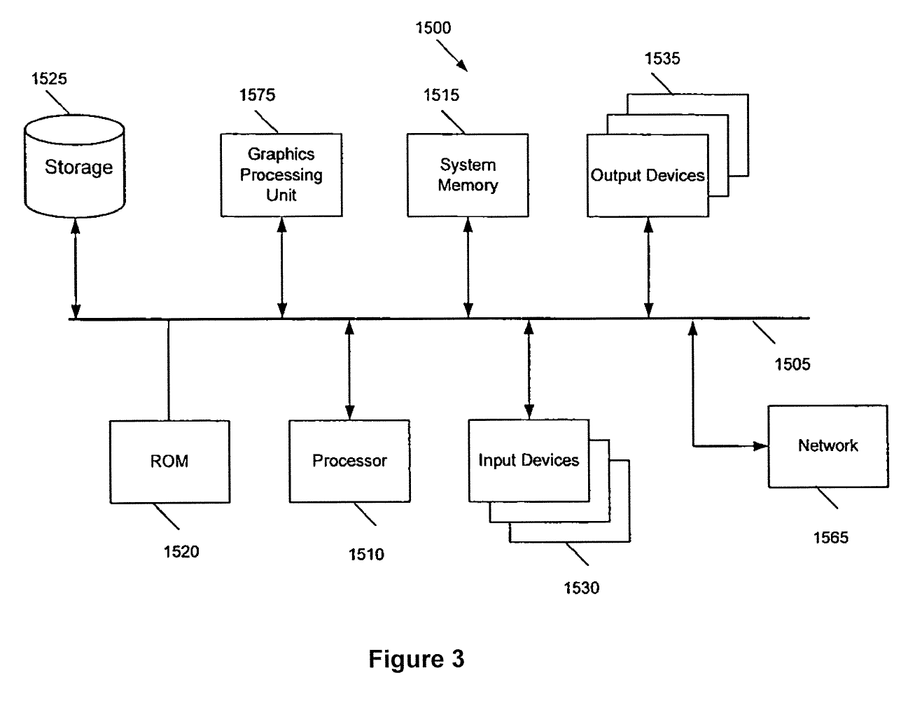

FIG. 3 conceptually illustrates a computer system with which some embodiments of the invention are implemented. The computer system 1500 includes a bus 1505, a processor 1510, a system memory 1515, a read-only memory 1520, a permanent storage device 1525, input devices 1530, and output devices 1535. In some embodiments, the computer system also includes a graphic processing unit (GPU) 1575.

The bus 1505 collectively represents all system, peripheral, and chipset buses that support communication among internal devices of the computer system 1500. For instance, the bus 1505 communicatively connects the processor 1510 with the read-only memory 1520, the system memory 1515, and the permanent storage device 1525.

From these various memory units, the processor 1510 (also referred to as central processing unit or CPU) retrieves instructions to execute and data to process in order to execute the processes of the invention. The read-only-memory (ROM) 1520 stores static data and instructions that are needed by the processor 1510 and other modules of the computer system. The permanent storage device 1525, on the other hand, is a read-and-write memory device. This device is a non-volatile memory unit that stores instruction and data even when the computer system 1500 is off. Some embodiments of the invention use a mass-storage device (such as a magnetic or optical disk and its corresponding disk drive) as the permanent storage device 1525. Other embodiments use a removable storage device (such as a floppy disk or Zip® disk, and its corresponding disk drive) as the permanent storage device.

Like the permanent storage device 1525, the system memory 1515 is a read-and-write memory device. However, unlike storage device 1525, the system memory is a volatile read-and-write memory, such as a random access memory. The system memory stores some of the instructions and data that the processor needs at runtime.

Instructions and/or data needed to perform processes of some embodiments are stored in the system memory 1515, the permanent storage device 1525, the read-only memory 1520, or any combination of the three. For example, the various memory units may contain instructions for processing multimedia items in accordance with some embodiments. From these various memory units, the processor 1510 retrieves instructions to execute and data to process in order to execute the processes of some embodiments.

The bus 1505 also connects to the input and output devices 1530 and 1535. The input devices enable the user to communicate information and select commands to the computer system. The input devices 1530 include alphanumeric keyboards, touch panels, and cursor-controllers. The input devices 1530 also include scanners through which an image can be input to the computer system. The output devices 1535 display images generated by the computer system. For instance, these devices display IC design layouts. The output devices include printers, pen plotters, laser printers, ink-jet plotters, film recorders, and display devices, such as cathode ray tubes (CRT), liquid crystal displays (LCD), or electroluminescent displays.

Also, as shown in FIG. 3, bus 1505 also couples computer 1500 to a network 1565 through a network adapter (not shown). In this manner, the computer can be a part of a network of computers (such as a local area network (“LAN”), a wide area network (“WAN”), or an Intranet) or a network of networks (such as the Internet). Finally, as shown in FIG. 3, the computer system in some embodiments also optionally includes a graphics processing unit (GPU) 1575. A GPU (also referred to as a visual processing unit or a display processor) is a dedicated graphics rendering device which is very efficient in manipulating and displaying computer graphics. The GPU can be included in a video card (not shown) or can be integrated into the mother board of the computer system along with the processor 1510. Also, the computer system 1500 may be used as a personal computer, a workstation, a game console, or the like. Any or all of the components of computer system 1500 may be used in conjunction with the invention. However, one of ordinary skill in the art will appreciate that any other system configuration may also be used in conjunction with the invention.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A method for detecting counterfeit copies of genuine items consisting of steps:
i. marking every genuine item with a UID;
ii. storing said UIDs in a remote database;
iii. The item is offered for sale in a store and a potential buyer may scan the UID marking an item;
iv. sending said scanned UID, location of purchase, and time of purchase, for authentication purposes, to a remote server in electronic communication with said database;
v. The remote server verifies whether said scanned UID which has been received exists in said database. If said UID does not exist, a message is returned to the user that the item is suspect of being counterfeit. If the UID does exist the following step follows:
vi. A cross reference of the UID, the location and time which have been received by the user, in order to identify if items bearing the same UID have been sold simultaneously in two or more locations. The system evaluates the probability of simultaneous sales, based on the time and distance between the two reports of the same UID sent to the system.
vii. If any irregularity arises in the cross examination process (an irregularity based on the cross examination of the UID, time and location data sent to the system) the system flags the UID of the item as counterfeit and sends a message accordingly to the potential buyer that the item is suspect of being counterfeit. If the system does not detect any irregularities in the cross examined data, and the UID of the item has never been flagged as potentially counterfeit, the system sends a message to the user indicating that the item is authentic.

2. The method of claim 1 wherein said step of checking said scanned UID is accomplished by checking whether said scanned UID relates to an item which has previously been sold or has been flagged for any other reason.

3. The method of claim 1 further storing batch information concerning times and endpoints of shipments of said genuine items.

4. The method of claim 1 further indicating if said item has been sold, and who it has been sold to, in said database, upon actual sales of said item.

5. The method of claim 4 further incrementing a ‘number of times sold’ counter every time said item is indicated as having been sold.

6. The method of claim 1 further providing a theft indication whereby UIDs of items that have been stolen are recorded as such.

7. The method of claim 1 further providing expiry indication whereby expiration dates for given UIDs are recorded in said database and checked against the current date.

8. The method of claim 3 wherein said verifiable proximity between two sales is determined by the physical distance between the points of sale and the times of deliveries of said shipments to said points of sale.

9. The method of claim 1 wherein said unique IDs are generated by means of a random number generator or random markings.

10. The method of claim 1 wherein said steps of scanning said item's ID and sending said scanned ID, location of purchase, and time of purchase to a server are accomplished by means of smartphone (as detailed above).

11. The method of claim 1 wherein said steps of scanning said item's ID and sending said scanned ID, location of purchase, and time of purchase to a server are performed by an entity selected from the group consisting of: purchaser; seller; wholesaler; retailer.
